(19) United States
(12) Patent Application Publication
(10) Pub. No.: US 2005/0197958 A1
(43) Pub. Date: Sep. 8, 2005

(54) Electronic account cash card security unit/process

(76) Inventor: Ronald Miles, Chicago, IL (US)

Correspondence Address: Ronald Miles, 8812 South Throop Street, Chicago, IL, 60620, US

(21) Appl. No.: 11/024,152

(22) Filed: Dec. 28, 2004

Related U.S. Application Data
(60) Provisional application No. 60/533,141, filed on Dec. 29, 2003.

(51) Int. Cl. G06F 17/60

(52) U.S. Cl. 705/41

(57) ABSTRACT

A method for programming an alternate instruction into the bank's computer 10, which is accessible only to an account owner, owning and operating a personalized account access security unit which can transmit a signal instruction 12 to the bank's computer so that no access can be granted to the owner's account while the signal is in process, to prevent the unauthorized use of an owner's account information in all avenues of the electronic transaction process wherever they can be made regardless of whether an owner's personal account information has fallen into the wrong hands.

### CROSS REFERENCE TO RELATED APPLICATIONS

This application is entitled to the benefit of Provisional Patent Application Ser. No. 60/533,141 filed 2003 Dec. 29.

### BACKGROUND

1. Field of Invention

This invention/process relates in the field of electronic security, pertaining to electronic transactions in connection with card and bank accounts in general.

2. Description of Prior Art

Although I am unfamiliar with any known prior art relating to this invention/process, it does seem, however, that Smart Card and biometric technology, which is now being used as a means for preventing the unauthorized access of a person's account information to commit fraud, does reflect a common goal.

Identity theft and credit card fraud mainly occurs when an imposter illicitly comes in possession of someone else's personal account information and then uses that information to make illegal transactions from that account.

Through the development of Smart Card and biometric technology, which uses electronic identification such as fingerprint, voice and facial recognition (through a database), the problem has been partially solved.

It seems, however, that the true nature of the cause for the problem has yet to be addressed. The reason that Smart Card and biometric identification is needed in the area of electronic transactions is due in part to the bank computer's program function for governing when electronic transactions can or cannot be made.

The bank computer's memory program for governing electronic transactions is divided, hypothetically, into two categories of instructions, positive and negative, with each category having an equal number of instructions for approving or denying transaction requests.

In the positive category, the bank's computer will authorize a transaction request under the following instructions:
1. When the account is open.
2. When the right account number or pin number is used.
3. When the amount of the request is equal to or less than the amount of the balance in the account.

In the negative category, the bank's computer will not authorize a transaction request under these instructions:
1. When the account is closed.
2. When the wrong account number or pin number is used.
3. When the amount of the request is greater than the amount of the balance in the account.

For this reason, anyone who comes in possession of a stolen debit or credit card and uses it at an ATM, can be approved for transaction, providing that they enter the right pin number and ask for the right amount.

This indicates that the instructional balance, which was originally intended for the computer's program, was never fully achieved. And although Smart Card and biometric systems are now being used with ATMs, online computers and other avenues of transactions, still, it has yet to be determined whether or not this technology can be manipulated.

Therefore, it should be obvious that as long as the bank computer's program for governing electronic transactions is geared for authorizing transaction requests when stolen information is used, that the problem of identity theft and credit card fraud will never be completely solved unless an alternative instruction can be processed into the computer's memory in order to restore the instructional balance which the computer needs for making the proper decision when stolen information is being used to draw from an account.

### SUMMARY

An electronic account security process comprising a personalized account signaling device.

### OBJECTS AND ADVANTAGES

Smart card and biometric identification, which can be used to identify the physical characteristics of an account owner, does have its advantages. Although, if a smart crook should somehow acquire the ingenuity to forge this technology, the result will be an increase in the ever growing number of identity theft related incidents happening today. However, the invention/process which I propose would provide all banking institutions with a means for correcting the weakness in the bank computer's authorization process, so in the event that a fingerprint, voice, or facial pattern can somehow be copied or manipulated by an identity thief, all access to financial accounts would still be denied.

Additional objects and advantages will become more evident from a consideration of the following descriptions and drawings.

### DRAWING FIGURES

In the drawings, each page is listed as a separate figure . . .

FIGS. 1 to 3 shows how the bank computer's instruction for authorizing transactions is flawed, and how it can be fixed.

FIG. 4 introduces the invention and its parts.

FIG. 5 shows two separate models of the same invention and its parts; also giving you an idea of which location the invention can be used.

FIG. 6 shows the invention set to be operated in its primary location.

FIG. 7 shows a screen display of invention's primary function.

FIG. 8 shows the invention set to be operated in its secondary location as a message relay to the primary location.

FIG. 9 shows a screen display of the message relay process in action, as its secondary function.

FIG. 10 shows you a diagram of the preferred embodiment of the security process.

FIG. 11 shows a diagram of an additional embodiment of the process.

FIG. 12 shows the completed operation of the invention/process.

FIG. 13 shows a similar diagram of the complete operation using graphic images of all the parts involved.

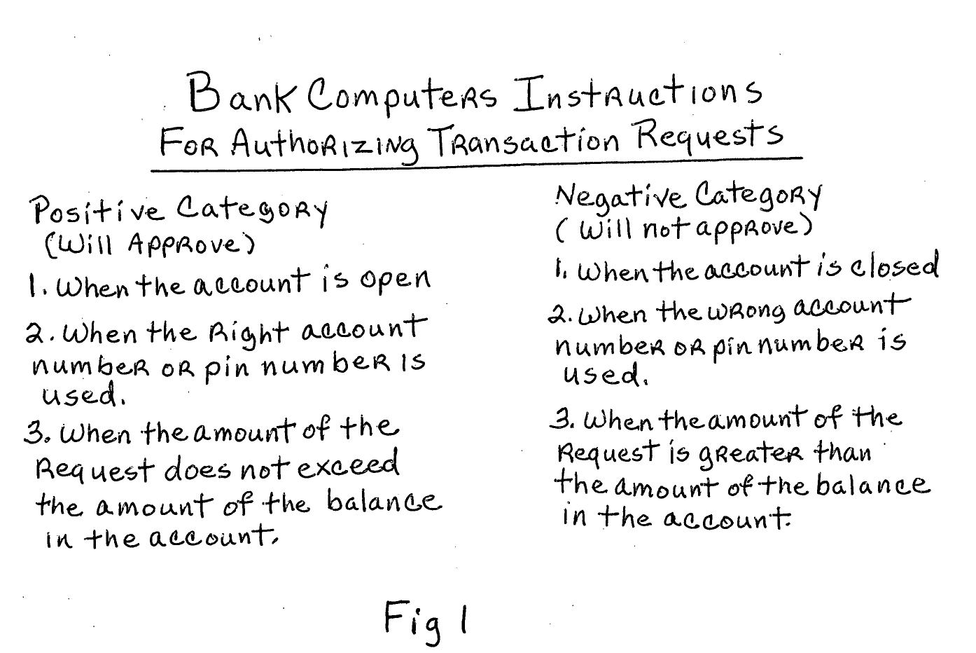

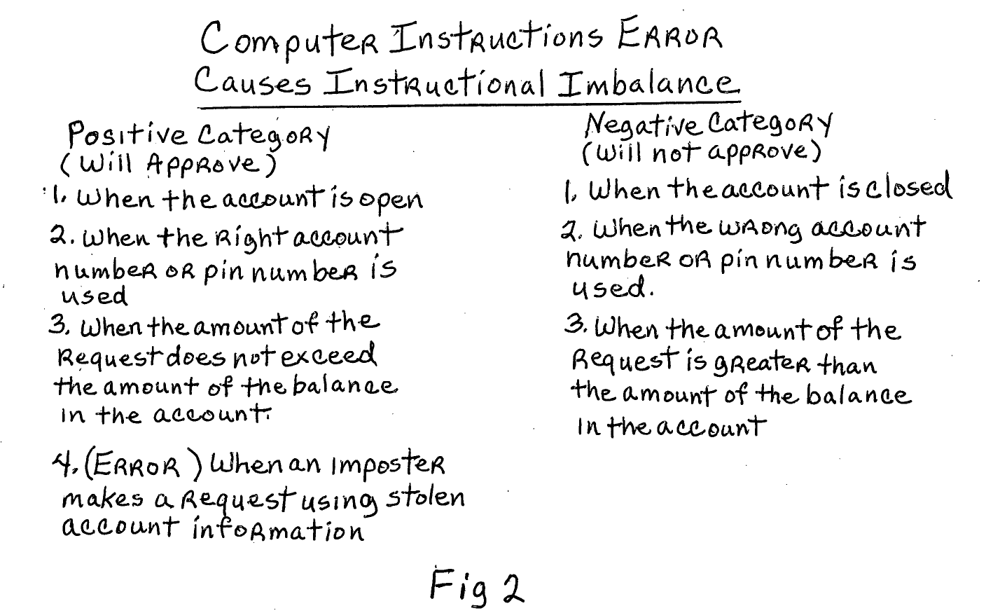

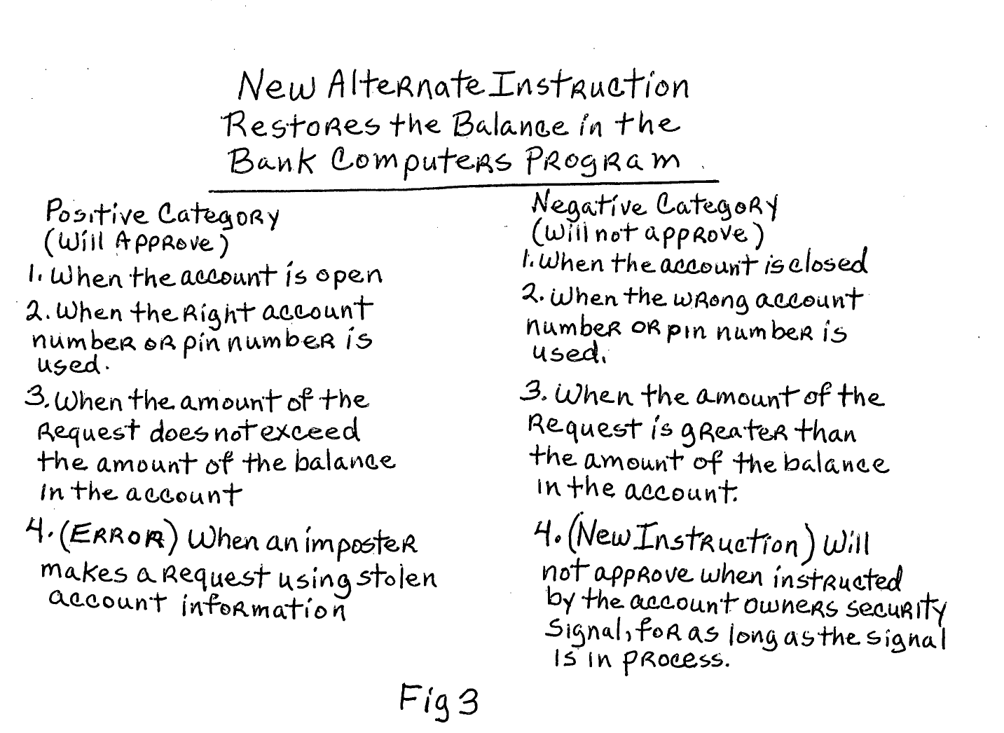

### REFERENCE NUMERALS IN DRAWINGS OF INVENTION

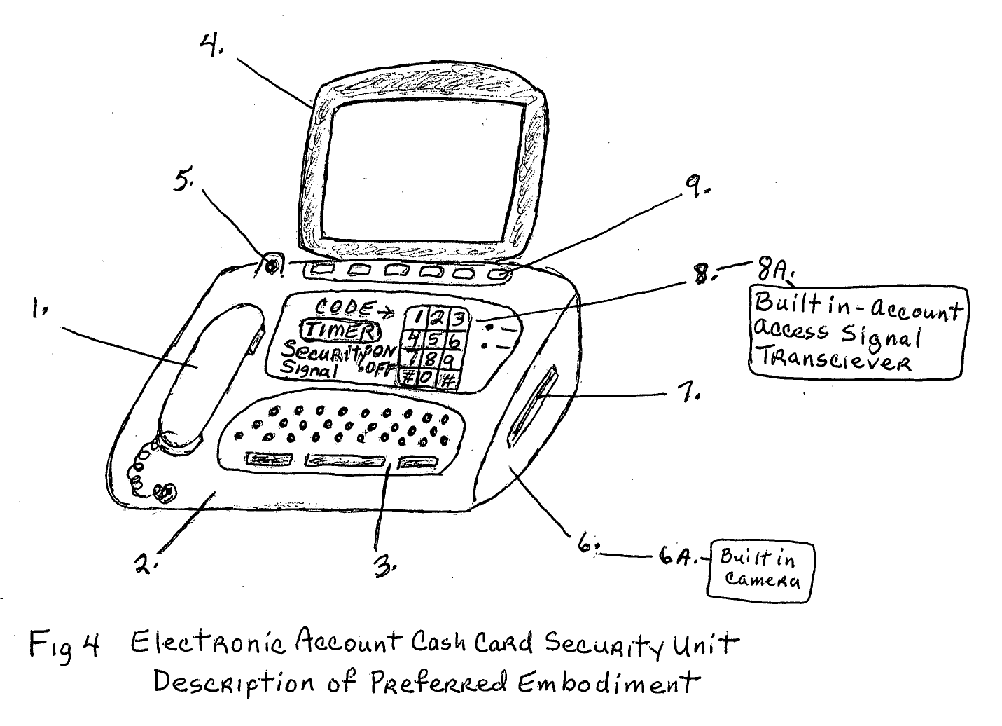

1 phone
2 base of security unit
3 typing buttons
4 display screen
5 built in-outer camera
6 built in-inner camera
7 card/document insert
8 account security control panel
8A built in-account access signal transceiver
9 display screen features (camera, picture & security clearance request buttons)
   Description—Preferred Embodiment of Invention—FIG. 4

The phone handset 1 is connected to the base 2 of the security unit with a cord, but can also be a wireless handset, if possible, and make calls to other units of its type. The phone dialing buttons would be located within the handset 1, but can also be placed on the base 2 if adequate room is available.

The base 2 can be flat or sloped with enough width to include all of the operating features within the outer surface of the unit.

The typing buttons 3 located just below the security control panel 8 prints text messages that can be shown on the display screen 4. Display screen 4 is flat from front to back with connecting hinges at the rear of the base 2, which enables it to fold over the unit like a laptop. Display screen 4 also has split screen capability for viewing several different images at once. All screen images can be transferred to other units of this type along with the phone call.

Outer built in camera 5, which is positioned within the upper surface of the unit, takes a picture of the caller and transmits that image on the screen 4. Outer camera 5 can also be positioned within the handset 1 if necessary.

Inner built in camera 6, which is positioned inside the card/document insert 7 about the slot with the camera lens facing downward having adequate focus for transferring full images of cards or documents that can be shown on screen 4.

Card/document-insert 7 has an opening on the side of the unit, but can also be positioned on the lower front or back of the unit and is used for inserting cards or documents that can be shown on screen 4.

Accounts security control panel 8, which operates the signal which protects the account, is located above the typing section 3 that features on/off security buttons with a keypad for entering a code for operating the signal. The code allows so that no one except the account owner may operate the signal.

Built in-account access signal transceiver 8A, which receives the access signal, then transmits the security signal and is operated by the account security control panel 8.

Display screen features 9 includes camera, picture and security clearance request buttons used for processing images of pictures and/or messages on screen 4.

Additional Embodiment of the Invention

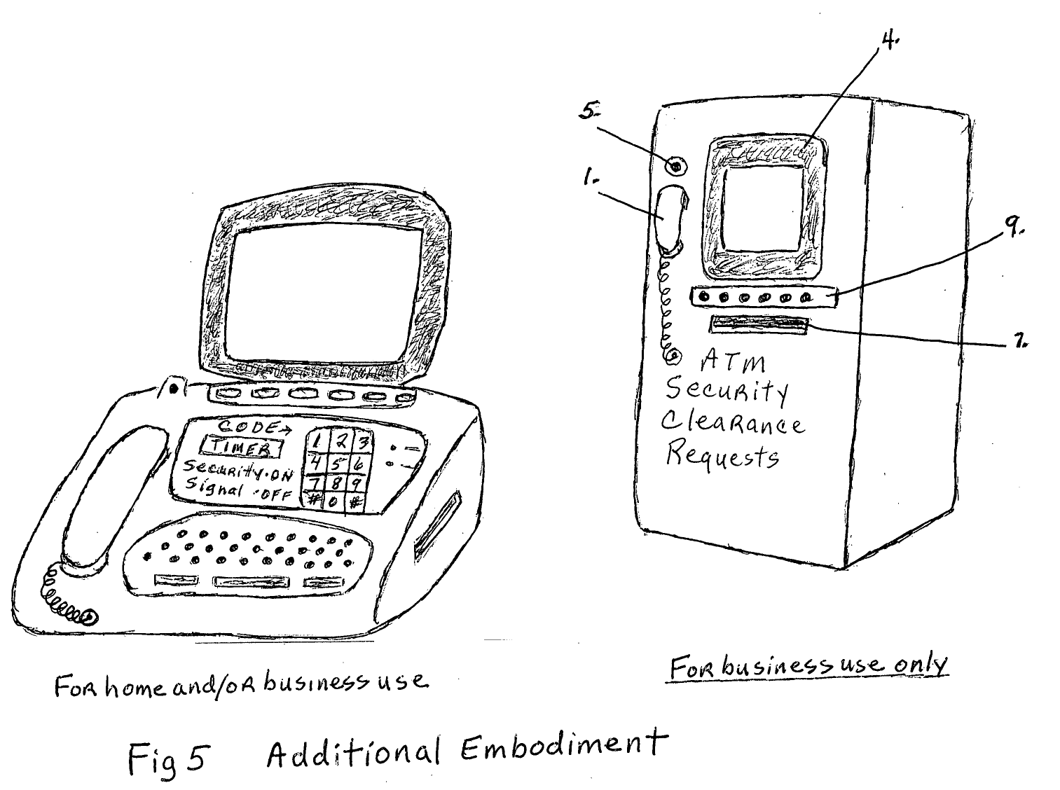

An additional embodiment of the invention is shown in FIG. 5A, which is a floor model for business use only.

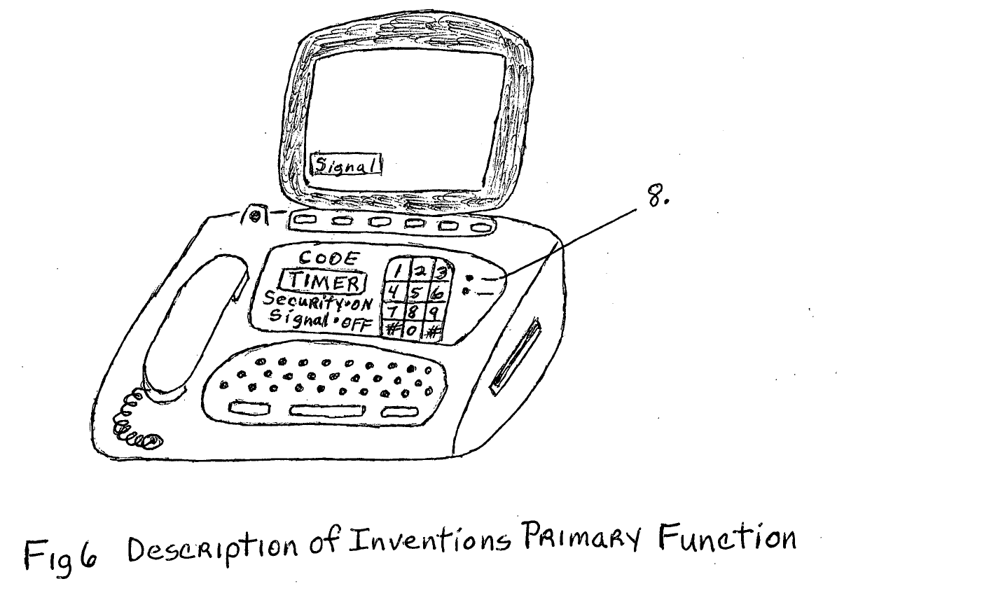

Alternative Embodiment of Invention—FIGS. 6 & 7

An alternative embodiment of the invention would be for the account owner to operate the security unit's signal while being away from home by simply dialing the home number and entering a special code number which would activate the signal to protect the account, and to turn off the signal, when desired. Also, the phone 1 and built in camera 5 does not necessarily have to be included in the security unit.

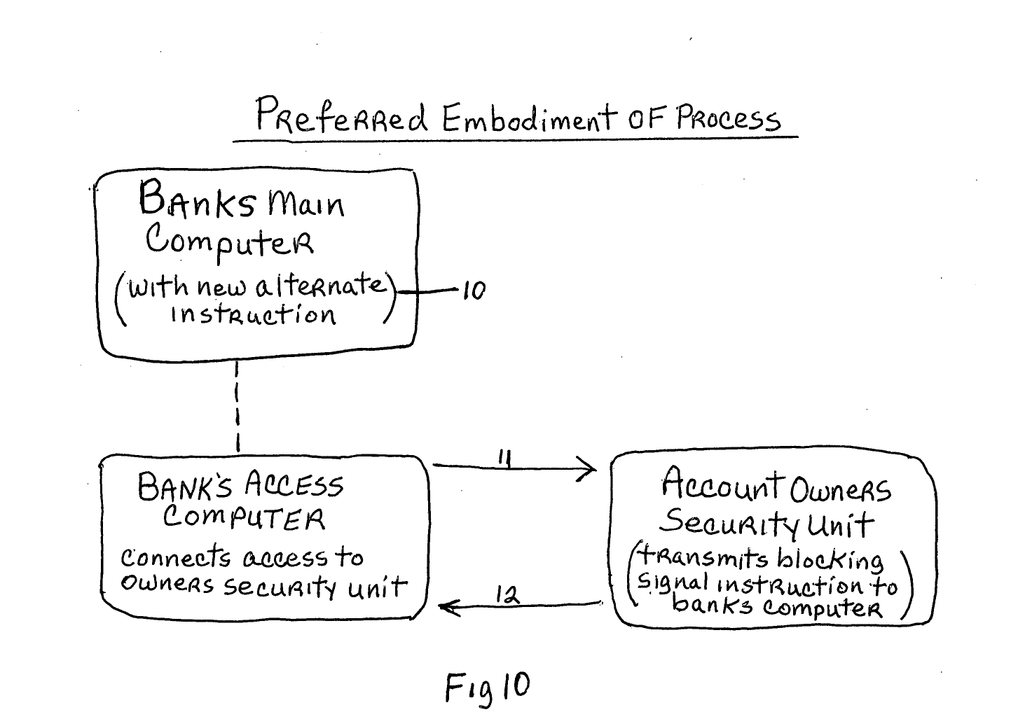

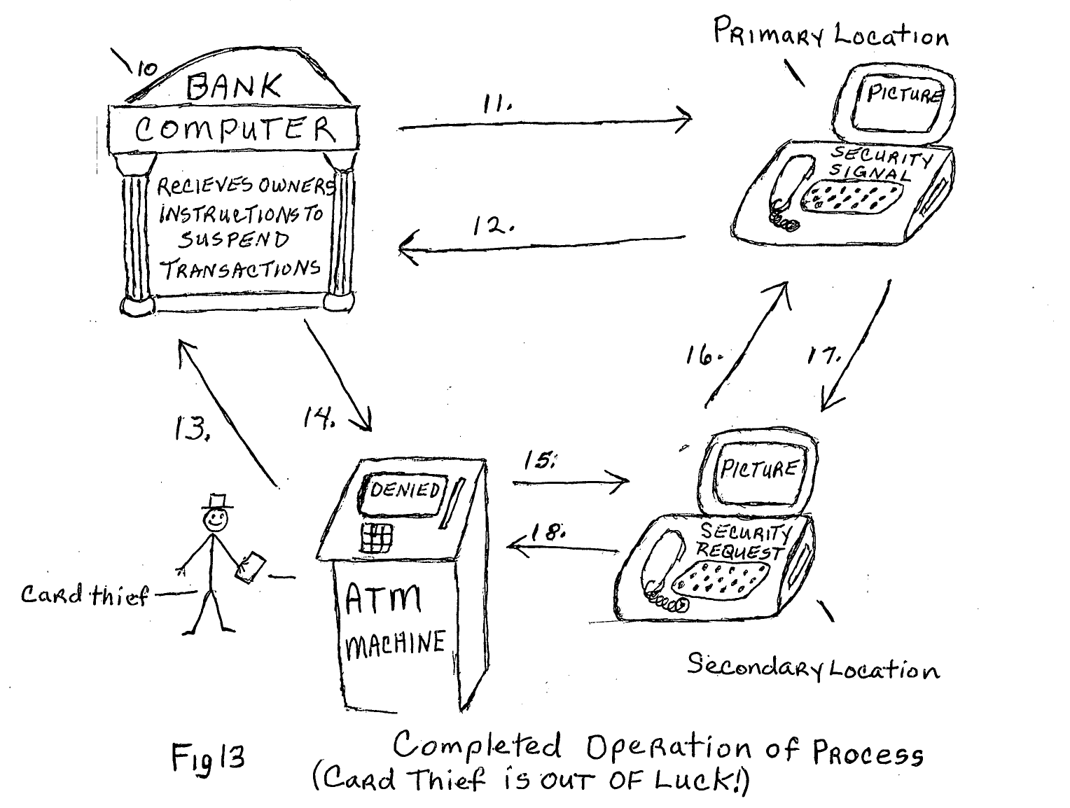

Reference Numerals in Drawings of Process—FIGS. 10 to 13

10 Bank's main computer is given a new instruction.
11 Account access computer connects access signal to owner's security unit.
12 Owner sends account blocking signal to the bank's computer.
13 Card user at ATM location makes transaction request to the bank's computer.
14 The account has now been blocked; the bank's computer will not allow the card user's request.
15 Card user must make a “Security Clearance Request,” to the account's owner, using the secondary unit from the ATM location (see FIG. ).
16 Card user processes the request to the account owner's primary unit.
17 Account owner receives the request and makes final decision.
18 Depending on the account owner's response, the card user may or may not draw cash from the ATM.

If the account owner releases the blocking signal 12, the account will become unblocked. The bank's computer will then allow the card user's request 14. If the account owner does not release the blocking signal, the card user's request is once again denied by the bank's computer.

Description—Preferred Embodiment of Process—FIG. 10

The preferred embodiment of the process as illustrated in FIG. 10 shows that the bank's main computer 10 has been programmed with an alternate blocking instruction which can only be accessed by the account owner's security unit 12. The bank's access computer connects access 11 to the account owner's security unit. The account's owner is then able to operate the security unit and transmit the blocking signal instruction to the bank's computer 12.

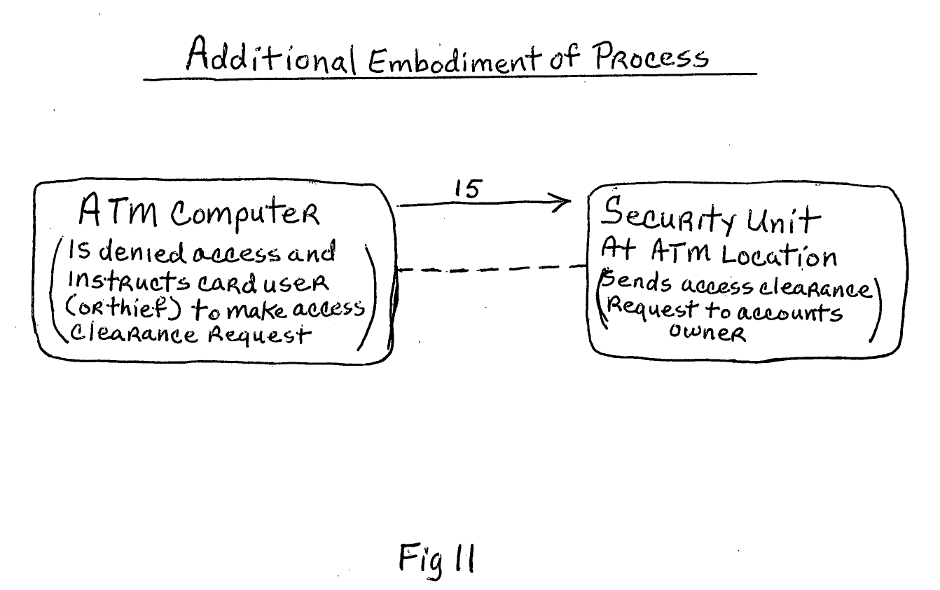

Additional Embodiments of Process—FIG. 11

The additional embodiment of the process as illustrated in FIG. 11 shows that the ATM computer with the arrow pointing towards a second security unity (which would be stationed at the same ATM location) 15 for which the card user (or thief) has been informed by the ATM computer that access has been denied and that the card user (or thief) must make an ‘access request’ directly to the account owner's unit, using the security unit that has been stationed at the ATM location, before access can be granted 18.

Additional Advantage (of Invention)

Surprisingly, most people today still do not own or use a computer. However, since all forms of electronic technology today uses some form of microprocessing or another, the security unit, because of its card/document insert, which allows it to receive and transmit full page images of personal or business letters or photographs that can be shown on screen, provides a similar computer concept which can allow for non computer users to participate more easily in the visual information exchange medium without the complex procedure of operating a standard computer.

Additional Advantage (of Process)

The very fact that an account owner would have the means of using a home operated device that can literally block all unwanted transactions from reaching their private financial account without the need of human assistance (i.e., bank person) gives the account owner a powerful advantage against identify theft.

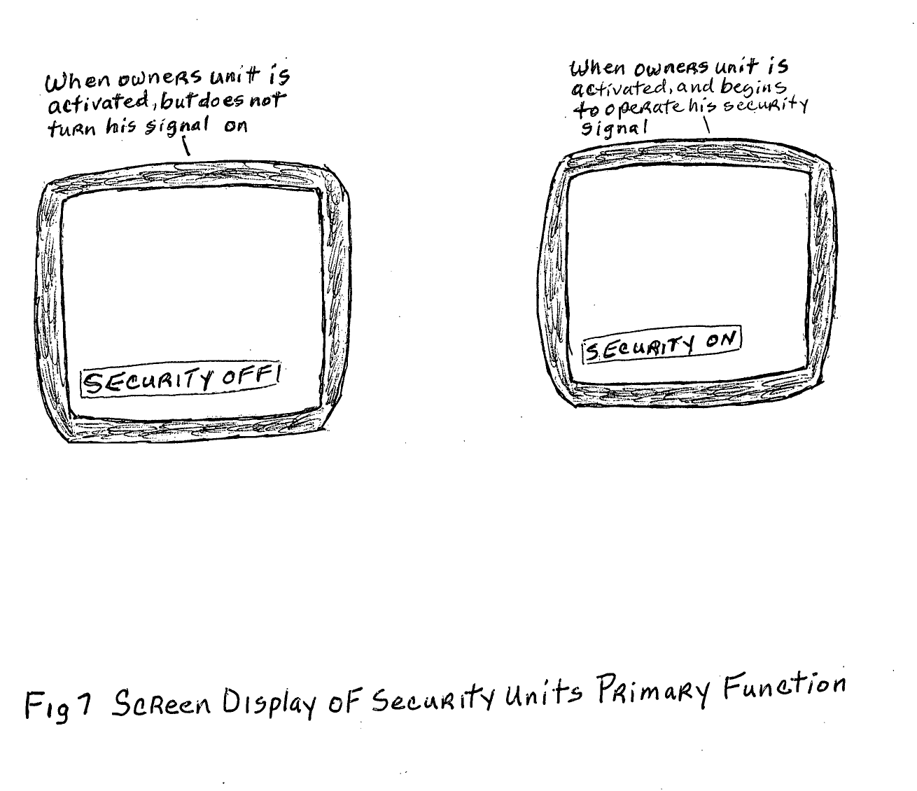

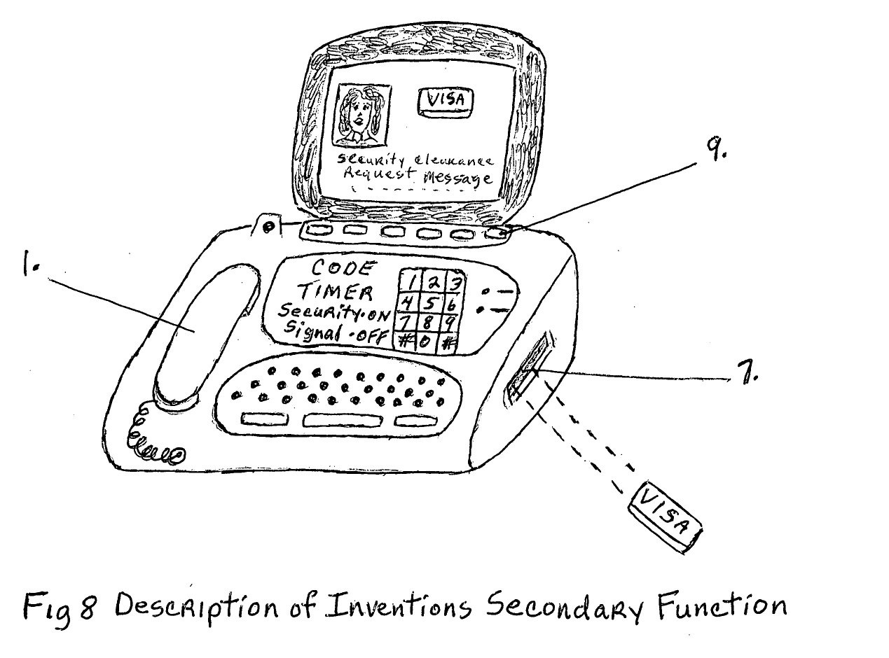

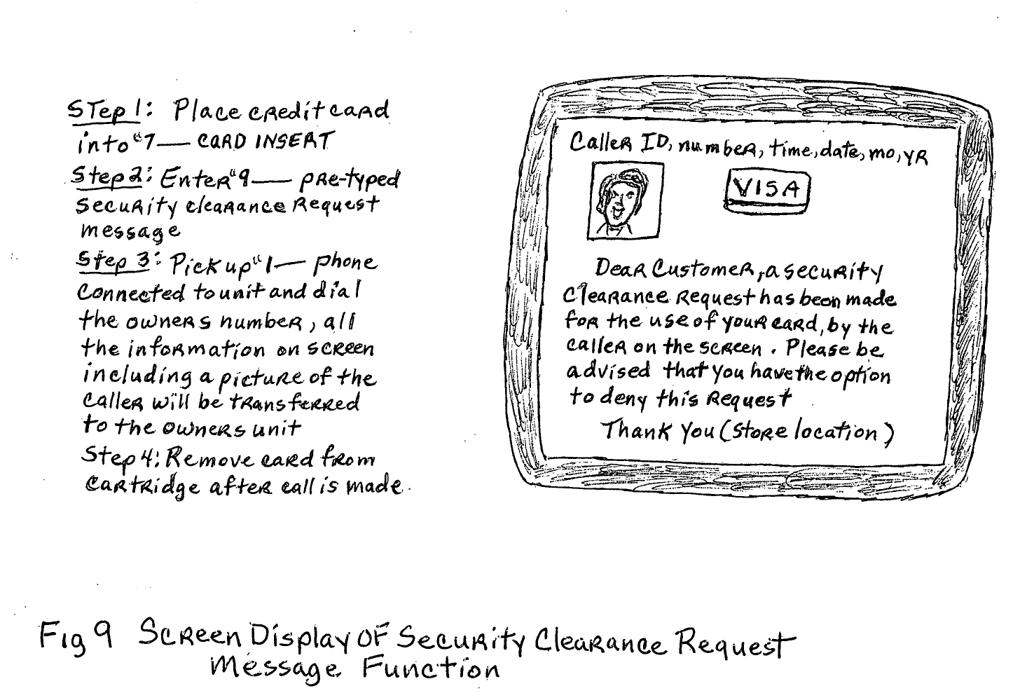

Operation—FIGS. 4, 5, 6, 7, 8, 10, 11, 12, 13

“The Electronic Account Cash Card Security Unit/Process,” can be described in other words as a personalized account access security system consisting of a home and/or business operated device which allows an account owner to transmit a blocking signal directly to the electronic address of their account to prevent unwanted access in the event that their personal account has fallen into the wrong hands. The groundwork for the development of the process requires that a new and alternate instruction is programmed within the bank's computer, which would be accessible only to an account owner owning and operating the personalized unit. The new instruction, when activated by the account owner's security signal, would freeze all transaction activity in connection with an owner's account while the signal is in effect, then afterwards, the account owner can then disconnect the signal to unblock the account for private use.

The security unit has two modes of operation, which are primarily and secondary, and is able to perform one operation with the bank's computer while performing a second operation with another unit of its type from separate locations.

In its primary mode, it is operated in the home of the account's owner and is used for transmitting a blocking signal directly to the bank's computer, which would prevent all access to the owner's account while the signal is in progress. In its secondary mode, it can be operated from any business location where electronic transactions can be made in connection with an owner's account, where it can be used to relay picture request messages to an account's owner from any person requesting permission to use the account, as well as to deter those from attempting illegal access.

This operational versatility of the security unit, combined with the aspect of programming an alternate security instruction into the bank's computer, has the potential for providing complete and round the clock security in all avenues of the electronic transaction process, regardless of whether someone's personal account information falls into the wrong hands.

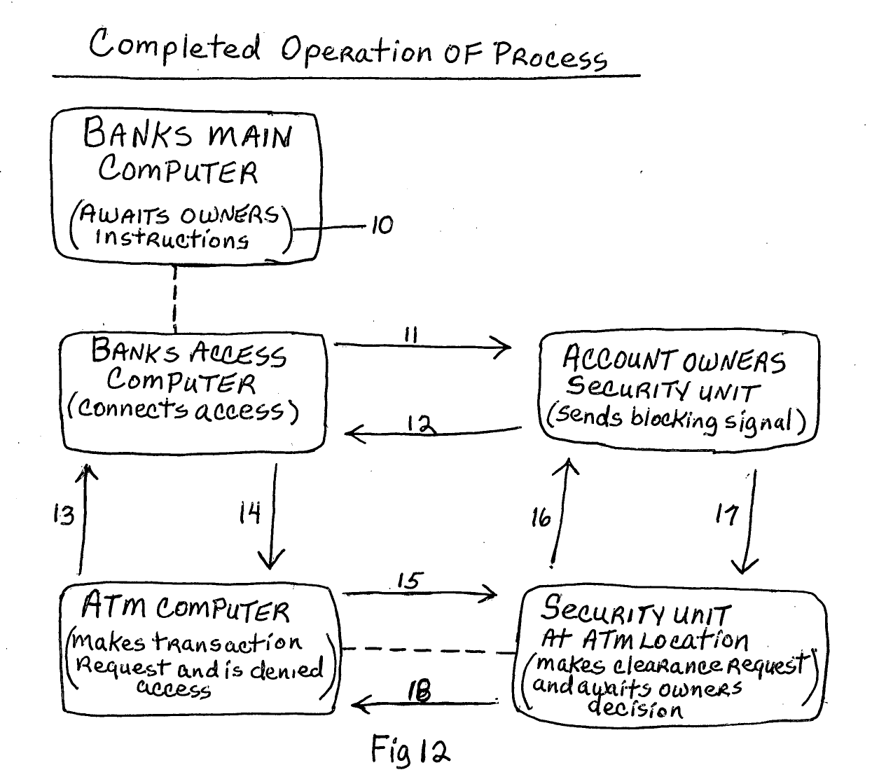

The complete operation of the account security process illustrated in FIG. 12 shows the position from which each part involved in the process are stationed and how they are all connected. The bank's main computer FIG. 12A shows a broken line connecting to the bank's access computer FIG. 12B to indicate that both bank computers are operated from the same location. The ATM computer FIG. 12D shows another broken line connecting it to the relay security unit, which is at the same location as the ATM. The account owner's security unit FIG. 12C has no broken line connecting it to either the bank's computer or the relay unit, showing that the account owner's primary unit is operating from a separate location all by itself while at the same time controlling the entire operation.

The direction of the arrows pointing toward each part represents a stage of the process; each stage is represented by a reference numeral.

The following is a description of how the invention/process operates in preventing a lost, borrowed or stolen credit card from being used at an ATM.

The bank's main computer is programmed with a new security instruction, which can be accessed only through an account owner's security unit 10. The bank's access computer connects access to the account owner's unit. Account owner then transmits the signal instruction to the bank's computer, which blocks access to the account 12. Attempted care user (or thief) makes bogus transaction request to the bank's computer 13. Because of the owner's signal instruction, the bank computer denies the ATM's request 14. ATM informs card user (or thief) that access has been denied and that an access request must be made to the account's owner using the optional security unit operating from the same ATM location 15. Card user (or thief) makes the “Security Clearance Access Request” call to the account's owner 16. (To process the request, the card user must: Slide the card into the card insert 7 inside the unit, enter a pre-typed request message 9 on the monitor screen 4, then pick up the phone connected to the unit and deal the owner's number. All of the information, including a picture of the caller, a picture of the card along with the typed request message, will be transferred to the monitor screen of the account owner's unit 16.

Account owner receives the visual request message, then makes final decision 17. If the account owner approves the request, the account owner can disconnect the security signal 12 to unblock the account so that the card user can be granted access 18. If the account owner does not approve the car user's (or thief's) request, the account owner simply leaves the signal turned on 12 to keep the account blocked so that card user (or thief) does not gain access 18.

Conclusion, Ramification, and Scope

Further advantages shows that the invention/process would not only prevent an illegal use of an owner's credit card at an ATM, but would also prevent illegal transactions that can be made by mail, over the phone, and online as well, because the account number, which is the main source of all transactions, would be under the personal security of the account owner's signal.

The security unit, as a secondary relay, would make a nice addition in banks, supermarkets, department stores, casinos, or any business where card account transactions can be made.

All banks that issue card services could cash in on extra profit because each account customer who buys a security unit would be required to pay a small monthly fee for the service of the signal.

If enough stores and businesses began using the security unit as a means for relaying text account messages to their customers, they would find those customers to be far more inclined to do repeat business with those establishments. And if enough banking institutions decided to adopt this type of account strategy in their banking systems, identify theft related cases, worldwide, could be drastically reduced.

1. A method for programming an alternate instruction into the bank's main computer whereby an account owner may use a personalized account access device to transmit a signal which instructs the bank's computer to deny all transaction requests in connection with the owner's account while the signal is in process.

2. A personalized account access security unit consisting of a phone, typing buttons, display screen, two built in cameras, a card/document insert and an account access signal transceiver.
